(19) United States
(12) Patent Application Publication
(10) Pub. No.: US 2008/0184185 A1
(43) Pub. Date: Jul. 31, 2008

(54) Method For Searching For a Similar Design Model

(75) Inventors: Ulrich Saelzer, Waiblingen (DE); Thomas Ulm, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/663,028

(22) PCT Filed: Sep. 16, 2005
(86) PCT No.: PCT/EP05/09979

§ 371 Date: Dec. 4, 2007

(30) Foreign Application Priority Data
Sep. 17, 2004 (DE) 10 2004 045 682.8
Nov. 3, 2004 (DE) 10 2004 053 034.3

(51) Int. Cl. G06F 17/50

(52) U.S. Cl. 716/11

(57) ABSTRACT

In a method, device and computer-readable medium for searching automatically for a similar or equal computer-accessible design model of an electronic library, multiple design models of components are provided. In a first phase, for each of these design models, a substitute design model is calculated, and then, using this substitute model, a set of attribute values of the design model. In a second phase, a computer-accessible outline of a component is provided. A substitute outline and a set of attribute values for the substitute outline are calculated. For each provided design model, the distance of the attribute value set of this design model from the attribute value set of the substitute outline is calculated. The design model which has the shortest distance from the outline is determined.

### CROSS REFERENCE TO RELATED APPLICATIONS

This application is a national stage of PCT International Application No. PCT/EP2005/009979, filed Sep. 16, 2005, which claims priority under 35 U.S.C. § 119 to German Patent Application Nos. 102004045682.8, filed Sep. 17, 2004, and 102004053034.3, filed Nov. 3, 2004, the entire disclosures of which are herein expressly incorporated by reference.

### BACKGROUND AND SUMMARY OF THE INVENTION

The present invention relates to a method, a data processing system and a computer-readable medium for searching automatically for a computer-accessible design model of an electronic library.

From German patent document DE 10240940 A1, a computer system and a method for comparing three-dimensional bodies is known. Data of a previously selected body is entered via a data entry unit. In a database, an automatic search takes place for bodies which are similar to the selected body.

Various methods of calculating the similarity of two design models are described, for example, in H. P. Kriegel, S. Brecheisen, P. Kroger, M. Pfeifle, M. Schubert: “Using Sets of Feature Vectors for Similarity Search on Voxelized CAD Objects”, Proceed. ACM SIGMOD Int. Conf on Management of Data (SIGMOD '03), June 9th-12th, 2003, San Diego, USA, pp. 587-598, available under http://www.dbs.ifi.lmu.de/Publikationen/Papers/sigmod03-sim.pdf, accessed on Sep. 16, 2004, B. Bustos, D. A. Keim, D. Saupe, T. Schreck, D. Vranic: “An Experimental Comparison of Feature-Based 3D Retrieval Methods”, 2nd Internat. Symposium on 3D Data Processing, Visualization, and Transmission (3DPVT'2004), Thessaloniki, September 6th-9th, 2004, available under http://www.dcc.uchile.cl/˜bebustos/publicaciones/BKS+04b.pdf, accessed on Sep. 29, 2004, and D. A. Keim, T. Schreck: “Methoden zur 3D Ähnlichkeitssuche—Kombinationen von Feature-Vektoren (methods for 3D similarity search—combinations of feature vectors)”, DFG Workshop Verallgemeinerte Dokumente und Digitale Bibliotheken (generalized documents and digital libraries)”, March 19th-20th, Frankfurt/Main, 2003.

In R. Osada, Th. Funkhouser, B. Chazelle, D. Dobkin: “Matching 3D Models with Shape Distributions”, Proceed. Internat. Conf. Shape Modeling & Applications, May 7th-11th, 2001, pp. 154-166, there is a description of how the similarity between multiple two/three dimensional design models with “shape distributions” is assessed.

An object of the present invention is to provide a method and a device that enable a user to refine a search, step-by-step, until a suitable design model for the user's applications is found.

This and other objects and advantages are achieved by a method, a data processing device, and a computer-readable medium according to the present invention in which multiple design models of components are specified.

In a first phase, for each of the design models, a substitute design model is calculated, and then, using this substitute model, a set of attribute values of the design model is calculated. In a second phase, a computer-accessible outline of a component is specified. A substitute outline and a set of attribute values for the substitute outline are calculated. For each specified design model, the distance of the attribute value set of this design model from the attribute value set of the substitute outline is calculated. The design model which has the shortest distance from the outline is determined.

The second phase is executed at least twice. In the first execution, as described above, a design model which has the shortest distance from the specified outline is determined. In the second execution, this determined design model is used as the specified outline.

The present invention makes it possible to automatically find, among the specified design models, a design model which is equal or similar to the specified outline. The invention requires no textual queries or specifications for a search. Such textual queries necessarily depend on the terms which are used. As is sufficiently known from searches in the Internet, in particular, the result of textual searches depends on the terms which are used and on the language. In contrast, the present invention does not depend on the language of a designer who originated a specified design model. The present invention avoids a manual classification of the specified design models, and uses exclusively the automatically calculated attribute values to determine a similar design model.

The present invention enables the user to refine the search step-by-step until a suitable design model for the user's applications is found.

The present invention reduces the danger of redundant work. That is, it reduces the danger that a design model is generated several times for the same component. It also reduces the danger that a component is newly designed although a design model could be reused. The invention makes it possible to search for similar design models for an outline, instead of merely determining which of the given design models are similar to each other.

The present invention also simplifies and supports the introduction and use of similar parts in different variants of a technical product, e.g., a motor vehicle. It supports the training of new designers, who use the invention to search for proven, released solutions for similar design tasks. It supports knowledge exchange and “knowledge management” between designers at different sites, who specify their design models to the method and all have access to the other specified design models. These designers use the method to find similar solutions from other designers at other sites.

The method makes it possible to use an electronic library which is put together from different electronic sub-libraries, e.g., from sub-libraries of different component manufacturers or from systems in which these components are used. A search for the most similar design model can be carried out without first having to change and standardize the various design models. In particular, it is not necessary to describe the given design models using uniform keywords or parameter values.

For example, in an electronic library, design models are stored in different data formats. The method uses the design models of this library. From each of these design models, the method according to the invention generates one substitute design model in the uniform geometry representation data format. It is not necessary to specify a uniform data format for the electronic library in advance, and, for example, to put only design models in this uniform data format into the library.

The substitute design models may describe the components as precisely as is necessary for the method according to the invention. A description of the surface, including the dimensions, of a component is required, but not a description of the inside. In this version, therefore, a data format which describes the surface of a component using plane elements is used as the geometry representation data format. Correspondingly, the substitute outline is also described using plane elements.

Further versions give specified attributes which are used for the search for similar design models. These attributes of a substitute design model include:
the surface of the substitute design model,
the volume of the substitute design model,
the quotient of the surface and volume of the substitute design model,
the greatest extent of the substitute design model in a specified coordinate system,
the volume of the smallest cuboid which completely envelops the substitute design model,
the geometrical center of gravity of the substitute design model, the density being assumed to be constant over space.

For the substitute outline, in each case the corresponding attribute is used and its value is calculated. These attributes have both a geometrical and consequently a physical meaning.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the method steps of the first phase;

FIG. 2 shows the method steps of the second phase; and

FIG. 3 shows the method steps of the second phase, if an attribute value cannot be calculated.

### DETAILED DESCRIPTION OF THE DRAWINGS

An exemplary embodiment of the present invention relates to the design of motor vehicle components. Typically, vehicles are manufactured in many different variants, so that the vehicles fulfill different customer needs. The aim is to use the same or at least similar components in different variants of vehicles, so that components are used in greater numbers of units. Therefore, reusing design models of components is desirable. The method, the design device and the computer-readable medium enable a designer, after generating a first outline for a component, to find a design model which is similar to the outline, and to reuse this design model for the new component. Generating a new design model is thus avoided.

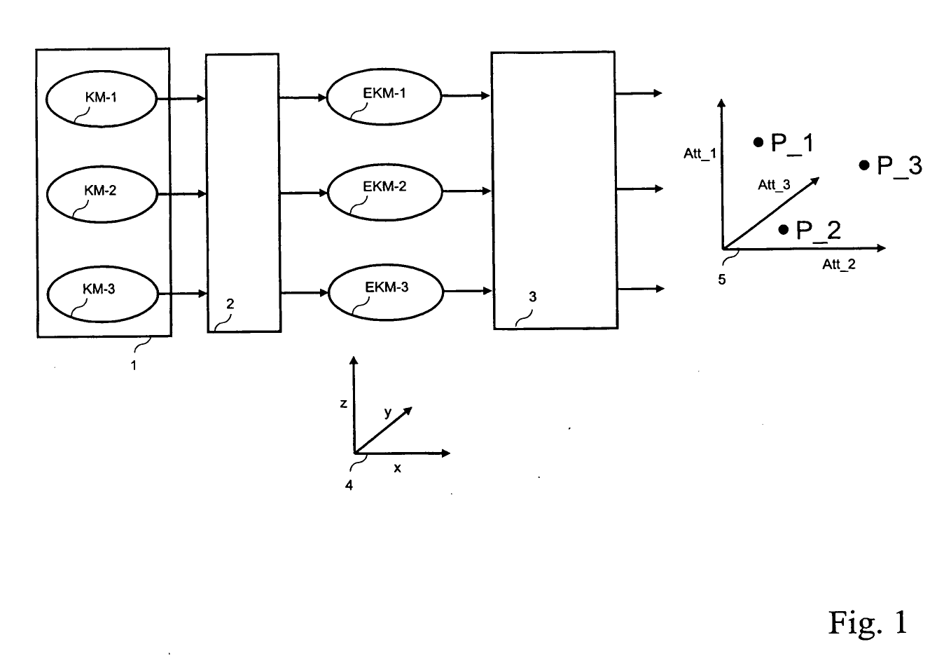

FIG. 1 shows the method steps of the first phase. Several computer-accessible design models are specified and stored in an electronic library 1. In FIG. 1, three design models KM_1, KM_2 and KM_3 are shown as examples. These design models may be three-dimensional CAD models. For example, the CAD models were generated using different CAD tools. It is possible that individual CAD models were generated by scanning a physical model.

For example, the electronic library 1 belongs to a data processing system for product data management (also called engineering data management). This version makes it possible to reuse a data processing system which is used in any case for product development, and avoids providing a database specially for the method. This version also makes it possible to use the design models which are used in any case in the product development process.

In one version, only completed, released design models are put into the library 1. Whenever a further design model is completed and released, it is put into the library 1. A completed and released new design version of a design model replaces an older design version of the same design model in the library 1.

In another version, it is provided that multiple design models are put into the library 1 for the same component, e.g., different design versions. For example, a released design model and at least one more up to date, but not yet released design model are put in for the component. The release status of a design model is stored in each case. Thus the search for similar components includes different design versions of the same component.

It is possible that different design models are put into the library 1 in different data formats, e.g., in different data formats of different CAD tools and/or in standardized data formats. The method does not assume any particular data format for design models.

The first phase of the method may be executed several times. In the first execution, a generator 2 generates, for each design model of the library 1, a computer-accessible substitute design model. For example, in FIG. 1 three substitute design models EKM_1, EKM_2 and EKM_3 are shown for the three design models KM_1, KM_2 and KM_3.

In one version, the substitute design models describe exclusively the surfaces of the components and thus of the design models, but not their insides. Each substitute design model consists of plane elements in the form of, for example, triangles or quadrilaterals. The substitute design model is generated using spline surfaces, for example. A decomposition of the surface model into plane elements in the form of triangles may be generated using tessellation, i.e., a decomposition of these spline surfaces into triangles. Efficient methods of tessellation are described in T. Akenine-Möller and E. Haines: “Real-time Rendering”, A. K. Peters, 2nd edition, 2002, pp. 512ff.

It is also possible to network the surfaces of the specified design models so that finite elements result. The finite element method is known from, for example, “Dubbel—pocket book for machine building”, 20th edition, Springer-Verlag, 2001, C 48 to C 50. In the design model, a specified set of points of the surface is defined. These points are called node points. Those plane elements of which the corner points are defined by these node points are called finite elements.

At least some of the components are metal sheets, for example. A specified design model for such a metal sheet describes a central surface of the metal sheet and its thickness. The thickness can vary from place to place of the central surface. For example, the central surface is a plane or a surface which is curved in space. The specified outline also describes a metal sheet, for example, by defining its central surface and its thickness.

The substitute design models are all generated in the same geometry representation data format. As the geometry representation data format, the “virtual reality modeling language” (VRML) format may be used. VRML is described, for example, in U. Debacher: “VRML introduction”, 2003, available under http://www.debacher.de/vrml/vrml.htm, accessed on Sep. 16, 2004. Alternative geometry representation data formats are, for example, “Jupiter tessellation” (JT), also known as “EDS direct model (JT)”, STL or STEP.

A uniform coordinate system 4 for the substitute design models is specified. In this coordinate system 4, a plane and an axis in this plane are specified. The origin of the coordinate system may be on this axis and in this plane. The generator 2 positions all substitute design models at the same position and in the same orientation in this coordinate system 4. For this purpose, for each substitute design model, two reference axes may be calculated through the substitute design model, e.g., in the direction of the greatest extent and in the direction of the smallest extent of the substitute design model. The substitute design model may be positioned in the coordinate system 4 so that the reference axis which runs in the direction of the greatest extent is identical to the specified axis, and the other reference axis lies in the specified plane.

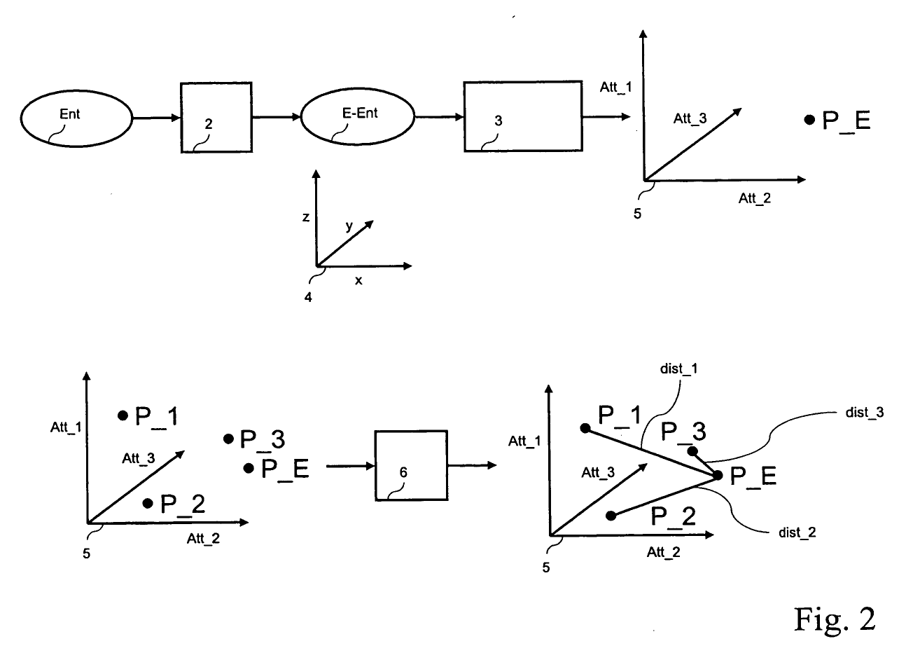

A set of calculable design model attributes is specified. In the example of FIG. 1, this set consists of the three attributes Att_1, Att_2 and Att_3. In practical applications, for example, 81 different design model attributes are specified. The design model attributes are ordinal-scaled or interval-scaled. They span a multidimensional space. For example, in FIG. 1 a three-dimensional coordinate system for the three-dimensional space in this example is shown. Because the attributes are ordinal-scaled or interval-scaled, each attribute forms one axis of an attribute coordinate system 5 for this multidimensional space. In the example of FIGS. 1 and 2, this attribute coordinate system 5 has three coordinate axes.

Examples of such design model attributes are:
the greatest extent of a specified design model in a coordinate system which is specified with this design model,
the greatest extent of a calculated substitute design model with reference to the specified coordinate system 4,
the three extents of a substitute design model in the x, y and z directions of the coordinate system 4,
a geometrical parameter of a smallest cuboid which completely envelops a calculated substitute design model,
a geometrical parameter of a smallest cuboid which completely envelops a specified design model,
a geometrical parameter of a smallest ellipsoid which completely envelops a calculated substitute design model,
a geometrical parameter of a smallest ellipsoid which completely envelops a specified design model,
the volume of the calculated substitute design model,
the surface of the substitute design model,
the ratio of the surface to the volume of the substitute design model,
the position of the volume center of gravity of the calculated substitute design model in the coordinate system 4, the substitute design model being treated as a massive body with the same weight at every point.

To calculate the volume of the substitute design model, the volume of the body, which is delimited by the plane elements of the substitute design model, may be calculated. Correspondingly, to calculate the surface of the substitute design model, the surface of the body, which is delimited by the plane elements of the substitute design model, may be calculated.

To calculate the position of the volume center of gravity of a substitute design model, the substitute design model may be treated as a massive body with the same weight at every point. The substitute design model describes the surface of this body. The center of gravity of this body in the specified coordinate system 4 is calculated, and functions as the volume center of gravity of the substitute design model.

Examples of geometrical parameters of an enveloping cuboid or ellipsoid are:
the length of the longest edge of the cuboid,
the length of the longest diagonal of the cuboid,
the volume of the cuboid,
the surface of the cuboid,
the ratio of the surface to the volume of the cuboid.

Further attribute values are determined by overlaying the appropriate substitute design model with a grid. Methods for such overlaying are described in H. P. Kriegel et al., op. cit., in B. Bustos et al., op. cit., in D. A. Keim, T. Schreck, op. cit., or in R. Osada et al., op. cit., for example.

A vector calculator 3 reads in the substitute design models, in the example of FIG. 1 the three substitute design models EKM_1, EKM_2, and EKM_3, in succession. For each substitute design model, the vector calculator 3 calculates the values which the substitute design model assumes for the specified computer-accessible design model attributes. These attribute values form a vector. This vector defines a point in the multidimensional space which the specified design model attributes span. For example, in FIG. 1 three such points P_1, P_2 and P_3 in the attribute coordinate system 5 are shown.

For example, the vector calculator 3 uses one of the methods which are described in H. P. Kriegel et al., op. cit., or in R. Osada et al., op. cit.

In the first phase, a pictorial representation of each component may be calculated. In the calculation, the appropriate substitute design model and a presentation program (“viewer”) for the uniform geometry representation data format are used. All pictorial representations may show the components from the same viewpoint. The pictorial representations are generated in a conventional data format, e.g., GIF or JPEG.

These attribute value items are stored in a data memory. Each attribute value item may be stored in the form of a data object. This data object carries a reference (“link”) to the substitute design model and design model for which the item was calculated. It also refers to the pictorial representation of the component.

The calculations of the first phase may be carried out when the data processing systems which are used for this purpose are not being used otherwise, e.g., at night or on the weekend. In an exemplary embodiment, a large number (e.g., several hundred) of workstations each with high calculating power are connected together, to calculate a substitute design model for each design model of the library, and then to calculate the vectors with the attribute values. These workstations are, for example, those with which by day design models are generated, edited and inserted into the library 1. This version makes it possible to use data processing systems which exist in any case, without restricting their normal use for designing components.

The second phase of the method may be applied whenever an outline of a component exists and a similar component to this component, with a design model which is put into the library 1, is searched for. The design models of the library 1 are searched. The design models of the library 1 are compared in succession with the outline of the component. The most similar design model is determined, and an identification and/or a pictorial representation of this most similar design model may be output.

For example, FIG. 2 explains the steps which are carried out in the second phase. A computer-accessible outline Ent is given. The generator 2 generates a substitute outline E-Ent for this component outline Ent, in the uniform geometry representation data format. The generator 2 positions the substitute outline E-Ent at the same position and in the same orientation in the specified coordinate system 4, for which purpose it calculates the two reference axes, as described above.

The vector calculator 3 reads in the substitute outline E-Ent and calculates the attribute values which the design model attributes assume for the substitute outline. These attribute values define a point in the attribute coordinate system 5. In the example of FIG. 2, this point is marked with P_E.

A distance calculator 6 reads in the attribute values of all substitute design models EKM_1, EKM_2, . . . which were calculated in the first phase. It also reads in the attribute values of the substitute outline E-Ent. In FIG. 2, four points P1, P2, P3 and P_E are shown as examples. The distance calculator 6 calculates the distance dist_i between the attribute values point P_i of the substitute design model EKM_i and the attribute values point P_E of the substitute outline E-Ent in the attribute coordinate system 5. For example, in FIG. 2 the distance dist_1 between P1 and P_E, the distance dist_2 between P2 and P_E and the distance dist_3 between P3 and P_E in the attribute coordinate system 5 are indicated.

The distance dist_i may be calculated according to the following calculation rule: Let Att_1, Att_2, . . . , Att_N be the N specified design model attributes. N weighting factors ω_{—}1, . . . , ω_N are specified. Let (x_{—}1⁽ⁱ⁾, . . . , x_N⁽ⁱ⁾) be the N attribute values which were calculated for the substitute design model EKM_i. Let (y_{—}1, . . . , y_N) be the N attribute values which were calculated for the substitute outline E-Ent. Then

$$dist\_i = {\sum }_{j = 1}^{N} ω\_j * {\vert {x\_j}^{( i )} - y\_j \vert}^{p}$$

with an exponent p>0. One version provides that p=2 and ω_{—}1= . . . =ω_N=1. Then the Euclidean distance

$$dist\_i = {\sum }_{j = 1}^{N} {( {x\_j}^{( i )} - y\_j )}^{2}$$

is used as the distance.

In the example of FIG. 2, the attribute values point P3 has the smallest distance from the attribute values point P_E of the substitute outline E-Ent. Accordingly, in the library 1, design model KM−3 is the one which is most similar to the outline Ent. This result is output, for example, by outputting an identifier of the design model KM_3 and of the component to which this design model KM_3 belongs. The reference which the data object for P3 carries may be evaluated. A copy of the determined design model KM_3 is generated, and a design system to edit this copy is opened.

It is possible that the vector calculator 3 cannot calculate the value of a particular attribute for the substitute outline E-Ent, e.g. because the substitute outline E-Ent was generated in an early stage of design and still contains no details which are required to calculate the value of this attribute. In this case, the values of this attribute are not taken into account in calculating the distances. For example, if the value of attribute Att_3 cannot be calculated for the substitute outline, the following distances are calculated and used:

$$dist\_i = {\sum }_{j = 1 , j \#3}^{N} ω\_j * {\vert {x\_j}^{( i )} - y\_j \vert}^{p}$$

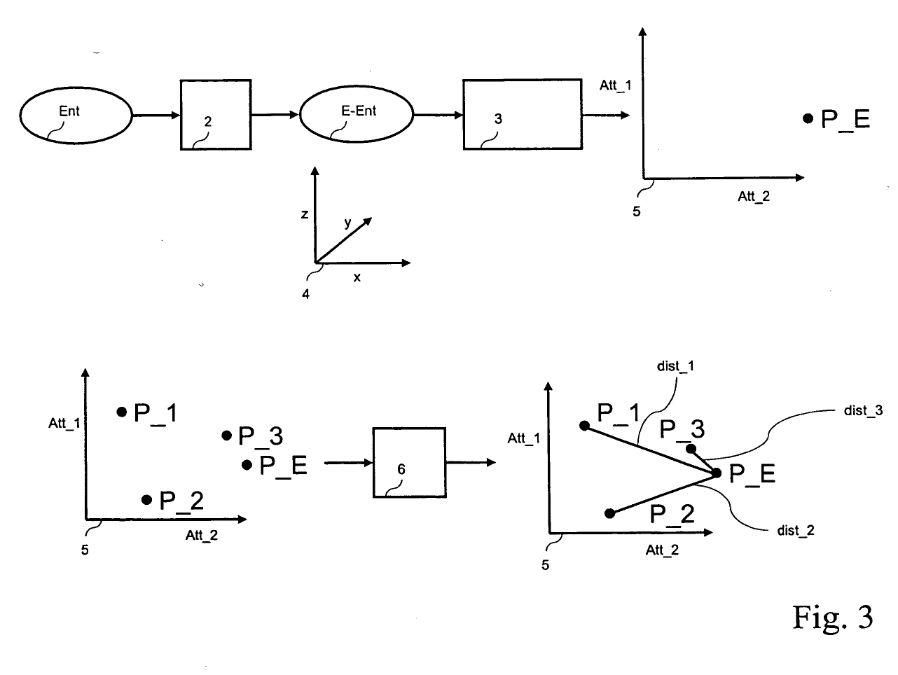

This is illustrated in FIG. 3. The values which the calculated substitute design models EKM_1, EKM_2 and EKM_3 take for the attribute Att_3 are not taken into account. The distances dist_1, dist_2 and dist_3 are thus distances in a modified two-dimensional attribute coordinate system 5 with the two coordinate axes Att_1 and Att_2.

In a further development, not only an identifier of the most similar design model is output, but also a sorted list of identifiers of several similar design models. For example, a maximum number M of elements of this list is specified. The M most similar design models are determined. Or all design models of which the distance dist_i is less than a specified upper limit are determined. The list is output sorted in ascending order of the distance dist_i. Therefore, an identifier of the most similar design model is stated first in the list.

In another further development, this list additionally shows the pictorial representations of the determined most similar components. These representations are generated using the determined design models. A user may choose one of the components by clicking on one of the pictorial representations. This selection functions as a starting point for a new search, for example.

In another further development, a user restricts the search. For this purpose, the user may specify a setpoint value or setpoint range for at least one of the specified N design model attributes. For example, the user defines a setpoint range for the greatest extent of the design model or substitute design model. The search for the most similar design model is restricted to those design models of which the attribute values are in this setpoint range.

Another version of this further development uses values of at least one parameter of which the values cannot be calculated from the specified design models KM_1, KM_2, . . . . Instead, these values are stored in the library 1. Each design model may be identified by a value of this parameter. Examples of such a parameter are:
a code number of the component,
a designation of the component,
uses of the component, e.g., use in particular series or vehicle variants,
materials from which the component is made,
release date of the design model,
production costs of the component,
purchase prices of the component,
quality data of the component, e.g., lifetime or failure frequency,
supplier of the component,
number of units used of the component,
degree of maturity and/or release status of the design model, e.g., released for production, released for design of a vehicle, outline.

The user specifies at least one search criterion which refers to one of these parameters. For example, the user specifies a time, and only those design models which were released before this time are searched. Or the user specifies an upper limit for production costs, and only those design models which refer to components of which the production costs are below the upper limit are searched.

These restrictions have the following effects on the method: first every substitute design model which fulfills all specified restrictions on the design model or the associated substitute design model are selected. For each of these selected substitute design models, the distance of the attribute value point from the attribute value point P_E of the substitute outline E-Ent is calculated. And the search for the most similar design model is carried out only among the selected design models.

When the identifier of the most similar design model or the list of the M most similar design models and thus components is output, the calculated attribute values and the identifying parameter values of these determined components may also be output. For example, the production costs of the M determined components are output, or the greatest extent of the calculated substitute design model is output. This makes it easier for a user to select one of the determined M most similar components.

A user may specify a setpoint range or setpoint value for at least one of the specified design model attributes. For example, an attribute value of the specified outline functions as the setpoint value. For each of the M most similar design models, the difference of the attribute value from the setpoint value or setpoint range is output, e.g., as a percentage difference. It is possible to output the attribute value as a percentage of the setpoint value. For example, the output says that the greatest extent of a determined design model should be not less than 80% and not more than 120% of the greatest extent of the outline.

The second phase is executed at least twice. In the first execution, as described above, a design model which has the smallest distance from the specified outline is determined. In the second execution, this determined design model is used as the specified outline. In the second execution, the steps of calculating the substitute outline and the attribute values for the substitute outline do not have to be executed, because the attribute values for the design model which was determined in the first execution are reused. In the second execution, in each case the distance between the attribute values of the determined design model and the attribute values of each other specified design model is determined. The specified design model which has the smallest distance from the design model which was determined in the first execution is determined. It is possible to execute the second phase a third time and a fourth time, in which case the design model which was determined in the previous execution is used as the outline, and from the design models which have not been determined until now, the one with the smallest distance from the design model which is used as the outline is determined.

The fact that the library 1 is constantly updated, for example, new design models are completed, released and put into the library, a further design model or design version for the same component is added to the library 1, a design model for a component is replaced by another design model for the same component, or a design model is removed from the library 1, may be taken into account. To take this into account, the first phase of the method is executed again after the expiration of a specified time period. In this way, attribute value vectors of substitute design models are moved, additional attribute value vectors for substitute design models of new design models are added, and attribute value vectors are removed.

In an advantageous version, for a repeated execution of the first phase, substitute design models are not calculated for all design models, but only for those which have been changed in the period since a specified instant. For example, this specified instant is the previous execution of the first phase, or an instant which is before the instant of the repeated execution of the first phase by a specified time period. Previously, which design models in the library 1 have been changed since the specified instant is determined. The first phase is executed again, with calculation of the appropriate substitute design model and attribute values, only for these design models. Additionally, a data object for an attribute value point is deleted if “its” design model is no longer present in the library 1. For example, the first phase is executed again every night, to be able to exploit workstations which cannot be used otherwise then. Substitute design models and attribute values are calculated for those design models to which write access and/or read access was made at least once in the last four weeks. The first phase is executed at least once per week, for example over the weekend.

### LIST OF REFERENCE SYMBOLS

| Reference symbol | Meaning |
|---|---|
| 1 | library with specified design models |
| 2 | generator to generate substitute design |
| | models |
| 3 | vector calculator to calculate attribute values |
| | of substitute design models |
| 4 | uniform coordinate system for substitute |
| | design models |
| 5 | attribute coordinate system |
| 6 | distance calculator |
| Att_1, Att_2, . . . | specified design model attributes |
| dist_i | distance between substitute outline and |
| | substitute design model |
| Ent | specified outline |
| E-Ent | calculated substitute outline |
| EKM_1, EKM_2, . . . | calculated substitute design models |
| KM_1, KM_2, . . . | specified design models |
| M | maximum number of design models which are |
| | determined |
| N | number of specified design model attributes |
| P_1, P_2, . . . | attribute value points with calculated |
| | attribute values of substitute design models |
| P_E | attribute value point with calculated attribute |
| | values of substitute outline |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-30. (canceled)

31. A method for automatically selecting a design model from among design models stored in a computer-accessible library, the method comprising:
providing in a computer-accessible library, multiple computer-accessible design models of components and a set of calculable design model attributes;
in a first phase of the method, calculating, for each provided design model, attribute values which the design model assumes for the provided calculable design model attributes;
in a second phase of the method, i) providing a computer-accessible outline of a component, ii) calculating attribute values which the design model attributes assume for the outline, iii) calculating, for each design model, the distance between the attribute values of the design model and the attribute values of the outline, and iv) determining, from the provided design models, a most similar design model, of which the attribute values have a minimum distance from the attribute values of the outline;
executing the second phase at least twice; and
in a final execution of the second phase, outputting as the outline an identifier of the provided design model which was determined in the first execution.

32. The method as claimed in claim 31, wherein:
in the first phase,
for each provided design model, a computer-accessible substitute design model is generated, all substitute design models being generated in the same geometry representation data format, and
attribute values, which the substitute design model of the design model assumes for the provided calculable design model attributes, are calculated and used as the attribute values of the design model, and
in the second phase,
a computer-accessible substitute outline for the outline is generated in the geometry representation data format, and
attribute values, which the design model attributes assume for the substitute outline, are calculated and used as the attribute values of the outline.

33. The method as claimed in claim 32, wherein:
at least one of the provided design models is provided in a first data format for three-dimensional design models, and
at least one other of the provided design models is provided in a second data format for three-dimensional design models.

34. The method as claimed in claim 32, wherein, as the geometry representation data format, a virtual reality modeling language format is used.

35. The method as claimed in claim 32, wherein, as the geometry representation data format, a data format which describes the surface of a design model at least approximately is used.

36. The method as claimed in claim 35, wherein:
the data format which is used as the geometry representation data format describes the surface using plane elements,
in generating the substitute design models, the surface of each of the provided design models is determined and decomposed into plane elements, and
in generating the substitute outline, the surface of the outline is determined and decomposed into plane elements.

37. The method as claimed in claim 35, wherein:
for each substitute design model,
a size of the surface of the substitute design model, as described by the geometry representation data format, is calculated, and
the calculated surface size is used as an attribute value of the substitute design model;
a size of the surface of the substitute outline, as described using the geometry representation data format, is calculated; and
the calculated surface size is used as an attribute value of the substitute outline.

38. The method as claimed in claim 35, wherein:
for each substitute design model,
a volume of the substitute design model as described by the geometry representation data format is calculated, and
the calculated volume is used as an attribute value of the substitute design model;
the volume of the substitute outline as described using the geometry representation data format is calculated; and
the calculated volume is used as an attribute value of the substitute outline.

39. The method as claimed in claim 38, wherein:
for each substitute design model,
a size of the surface of the substitute design model as described by the geometry representation data format is calculated, and
the quotient of the calculated surface size and calculated volume is used as an attribute value of the substitute design model;
a size of the surface of the substitute outline as described using the geometry representation data format is calculated; and
the quotient of the calculated surface size and calculated volume is used as an attribute value of the substitute outline.

40. The method as claimed in claim 32, wherein:
a three-dimensional coordinate system is provided,
for each substitute design model, the greatest extent of the substitute design model in the provided coordinate system is calculated and used as an attribute value of the substitute design model, and
the greatest extent of the substitute outline in the provided coordinate system is calculated and used as an attribute value of the substitute outline.

41. The method as claimed in claim 32, wherein:
a three-dimensional coordinate system is provided,
for each substitute design model, a cuboid which envelops the substitute design model is calculated and a value of at least one geometrical parameter of this enveloping cuboid with reference to the provided coordinate system is calculated and used as an attribute value of the substitute design model, and
a cuboid which envelops the substitute outline is calculated, and a value of at least one geometrical parameter of the enveloping cuboid with reference to the provided coordinate system is calculated and used as an attribute value of the substitute outline.

42. The method as claimed in claim 32, wherein:
a three-dimensional coordinate system is provided,
for each substitute design model, a center of gravity is calculated and a position of each substitute design model in the coordinate system is used as an attribute value of the substitute design model, and
a center of gravity of the substitute outline is calculated and a position of the substitute outline in the coordinate system is used as an attribute value of the substitute outline.

43. The method as claimed in claim 32, wherein:
a three-dimensional coordinate system and an axis in the coordinate system are provided, and
for each provided design model,
a reference axis in the substitute design model of the design model is calculated, and
the substitute design model is oriented in the provided coordinate system in such a way that the calculated reference axis lies on the provided axis.

44. The method as claimed in claim 43, wherein the reference axis of each substitute design model is calculated so that it runs in a direction of the greatest extent of the substitute design model in the coordinate system.

45. The method as claimed in claim 43, wherein:
a plane in the provided coordinate system is provided so that the provided axis lies in the provided plane, and
for each provided design model,
a further reference axis in the substitute design model is calculated, and
the substitute design model is oriented in the coordinate system in such a way that the calculated further reference axis lies in the provided plane.

46. The method as claimed in claim 45, wherein the further reference axis of each substitute design model is calculated so that the further reference axis runs in a direction of the smallest extent of the substitute design model in the coordinate system.

47. The method as claimed in claim 31, wherein:
the first phase of the method is executed at least twice,
an update instant is provided,
for each provided design model, an instant of a last change of the design model is determined, and
in the second execution of the first phase for a provided design model,
a substitute design model is calculated if the instant of the last change of the design model is after the updating instant, and
otherwise, in the second execution, the substitute design model which was calculated in the first execution of the first phase is reused.

48. The method as claimed in claim 31, wherein:
on at least one execution of the second phase, at least one of the provided design model attributes is selected and a setpoint range for the selected attribute is provided,
every design model of which the attribute value for the selected attribute is within the provided setpoint range is selected,
the distance calculation for the selected design models is carried out, and
a selected design model having the minimum distance is determined.

49. The method as claimed in claim 31, wherein:
a component parameter of which the values cannot be calculated from the provided design models of the components is provided,
on at least one execution of the second phase, a setpoint range is provided for the component parameter,
every design model of which the parameter value is within the provided setpoint range is selected,
the distance calculation for the selected design models is carried out, and
a selected design models having the minimum distance is determined.

50. The method as claimed in claim 31, wherein in determining a design model, the provided design models are sorted according to the distances of the attribute values, which are calculated for the design models, from the attribute values which are calculated for the outline.

51. The method as claimed in claim 31, wherein:
multiple data processing systems are connected at least temporarily into one computer network, and
the method steps of the first phase are executed by the computer network.

52. The method as claimed in claim 51, wherein at least one of the connected data processing systems is used before the first phase to generate at least one of the provided design models.

53. The method as claimed in claim 51, wherein to carry out the method steps of the first phase, the computer network is used in a period in which the at least one data processing system is not being used to process one of the provided design models.

54. A digital storage medium with electronically readable control signals, which can work with a programmable data processing system so that a method as claimed in claim 31 can be carried out.

55. A computer-readable medium which can be loaded into the internal memory of a computer, and includes software sections with which a method as claimed in claim 31 can be carried out if the product runs on a computer.

56. A computer-readable medium which is stored on a computer-readable medium and has program means which can be read by a computer, and which cause the computer to carry out a method as claimed in claim 31.

57. A data processing system comprising:
an information passing interface to an electronic library with multiple computer-accessible design models of components; and
an information passing interface to a data memory with a computer-accessible outline of a component; wherein,
the data processing system is configured,
in a first phase, to calculate, for each design model, attribute values which the design model assumes for a set of provided calculable design model attributes;
in a second phase, i) to calculate attribute values which the provided design model attributes assume for the provided outline, ii) to calculate, for each design model, the distance between the attribute values of the design model and the attribute values of the outline, and iii) to determine, from the library, a design model, of which the attribute values have a minimum distance from the attribute values of the outline, as the most similar design model;
the data processing system is configured to execute the second phase at least twice, and
in the second execution of the second phase, the data processing system uses the provided design model determined in the first execution as the outline.

58. The data processing system as claimed in claim 57, wherein:
the data processing system is configured to execute the following steps in the first phase,
i) for each design model of the library, generating a computer-accessible substitute design model, the data processing system generating all substitute design models in the same geometry representation data format, and
ii) for each design model, calculating attribute values which the substitute design model of the design model assumes for the design model attributes, and using the calculated attribute values as the attribute values of the design model, and
the data processing system is configured to execute the following steps in the second phase,
i) generating a computer-accessible substitute outline for the outline in the geometry representation data format, and
ii) calculating attribute values, which the provided design model attributes assume for the substitute outline, and using of the calculated attribute values as the attribute values of the outline.

59. A computer-readable medium which includes:
an information passing interface to an electronic library with multiple computer-accessible design models of components; and
an information passing interface to a data memory with a computer-accessible outline of a component; wherein,
the computer-readable medium is configured to execute the following step in the first phase,
i) for each design model, calculating attribute values which the design model assumes for a set of provided calculable design model attributes,
the computer-readable medium is configured to execute the following steps in a second phase,
i) calculating attribute values which the provided design model attributes assume for the provided outline;
ii) for each design model, calculating the distance between the attribute values of the design model and the attribute values of the outline; and
iii) from the library, determining a design model, of which the attribute values have a minimum distance from the attribute values of the outline, as the most similar design model;
the computer-readable medium is configured to execute the second phase at least twice; and
the computer-readable medium is configured such that in the second execution of the second phase, the computer-readable medium uses the provided design model determined in the first execution as the outline.

60. The computer-readable medium as claimed in claim 59, wherein:
the computer-readable medium is configured to execute the following steps in the first phase,
i) for each design model of the library, generating a computer-accessible substitute design model, the computer-readable medium generating all substitute design models in the same geometry representation data format; and
ii) for each design model, calculating attribute values, which the substitute design model of the design model assumes for the design model attributes, and use of the calculated attribute values of the design model;
the computer-readable medium is configured to execute the following steps in the second phase,
i) generating a computer-accessible substitute outline for the outline in the geometry representation data format, and
ii) calculating attribute values, which the provided design model attributes assume for the substitute outline, and using the calculated attribute values as the attribute values of the outline.
